(19) United States
(12) Patent Application Publication
(10) Pub. No.: US 2006/0024652 A1
(43) Pub. Date: Feb. 2, 2006

(54) Tooth model for dentistry practical training

(76) Inventors: Kazuhisa Ose, Kyoto (JP); Funakoshi Satoru, Kyoto (JP)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/526,440

(22) PCT Filed: Aug. 28, 2003
(86) PCT No.: PCT/JP03/10997

§ 371 Date: Mar. 2, 2005

(30) Foreign Application Priority Data
Sep. 2, 2002 (JP) 2002-256998

(51) Int. Cl. G09B 23/28

(52) U.S. Cl. 434/263

(57) ABSTRACT

A tooth model for dentistry practical training capable of correct shape measurement using laser light is disclosed.

The tooth model for dentistry practical training having a tooth crown portion 1 formed as an imitation of the shape of a tooth is characterized that at least the tooth crown portion 1 is made of a tooth crown portion forming material having non-transparency or semi-transparency, a center-line average roughness Ra of the surface of the tooth crown portion 1 is 0.1 μm or more and less than 10 μm, and a light reflectance of the surface of the tooth crown portion 1 is 70% or higher for light of 700 nm in wavelength. The color difference ΔE*ab from a standard white color of the tooth crown portion forming material is 15 or less. Since the shape of the tooth crown portion can be correctly measured by a non-contact, high speed, three-dimensional shape measuring instrument, by using this tooth model, results of various kinds of a treatment practice and a preparation practice can be correctly evaluated in the educational field.

### TECHNICAL FIELD

The present invention relates to a tooth model for dentistry practical training, and particularly, to a tooth model for dentistry practical training capable of correct shape measurement using laser light.

### BACKGROUND ART

Tooth models for dentistry practical training have been conventionally employed widely in the educational field including a dental collage, a dental technician training school and the like, and as one example of such a tooth model for dentistry training, for example, Japanese Patent Publication No. 2506212 discloses a denture that can be easily mountable into or demountable from a tooth placing site of a alveolar model using an elasticity of a leaf spring, and Japanese Laid-Open Patent Publication No. 2002-628 discloses an tooth models having a structure in which a protrusion fitting in a recess formed in the a alveolar model side is provided to a tooth root portion.

In various educational facilities, shape measurement using laser light has been on the way to a practical use on a tooth model after a preparation practice or an endodontic treatment practice (filling practice) in order to evaluate results of such treatment practices using a tooth model, whereas in a case of a general plastic tooth model described in the above publications, a glossiness of the surface of a tooth, when being illuminated with laser light, is too large to cause scattering of laser light at a proper level, thereby disabling correct shape measurement of a tooth using laser light to be conducted.

The object of the present invention is to provide a tooth model for dentistry training capable of correct shape measurement using laser light in order to solve the problem.

### DISCLOSURE OF THE INVENTION

A tooth model for dentistry training of the present invention has a tooth crown portion formed as an imitation of the shape of a tooth, wherein the tooth crown portion is made of at least a tooth crown portion forming material having non-transparency or semi-transparency, a center-line average roughness Ra of the surface of the tooth crown portion is 0.1 μm or more and less than 10 μm and a light reflectance of the surface of the tooth crown portion is 70% or higher for light of 700 nm in wavelength.

A tooth model for dentistry training of the present invention is the tooth model having the features, wherein a color difference ΔE*ab from a standard white color of the tooth crown portion forming material is 15 or less.

### BRIEF DESCRIPTION THE DRAWING

FIG. 1 is a view showing an example of a schematic shape of a tooth model for dentistry training of the present invention.

### BEST MODE FOR CARRYING OUT THE INVENTION

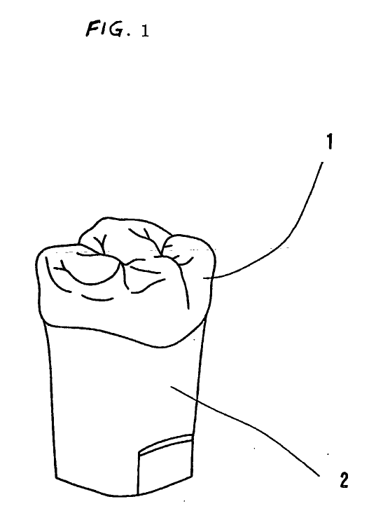

Description will be given of the present invention showing an example of a schematic shape of a tooth model for dentistry training of the present invention in FIG. 1.

A tooth model for dentistry training of the present invention, as shown in FIG. 1, has a tooth crown portion 1 formed artificially as an imitation of a human tooth and the tooth crown portion 1 is of a single layer structure or a multilayer structure. That is, the tooth crown portion 1 of the tooth model of the present invention may be of a multilayer structure having an enamel layer on the surface thereof, as in an actual tooth (a natural tooth), and an dentin in the interior, or alternatively may be of a single layer structure in which the enamel layer and the dentin are formed from the same material. A pulp cavity may be formed in the interior of the dentin, and, as exemplified in FIG. 1, the tooth crown portion 1 is preferably connected to the tooth root portion 2 so as to be capable of installment in a prescribed alveolar model.

In a tooth model of the present invention, the tooth crown portion 1 is made of at least a tooth crown forming material having non-transparency or semi-transparency and the tooth crown portion 1 has fine concavity and convexity in the surface thereof. With a surface profile having excessively smaller peak and valley height and roughness spacing of the tooth crown portion 1, no scattering of laser light in shape measurement using laser light is caused in reflection of the laser light in shape measurement on the surface of the tooth crown portion 1 to thereby disable shape measurement of the tooth model, which is because the surface of the tooth crown portion has many of inclined surfaces relative to a laser light oscillator and laser light reflected on the surface of the tooth crown portion is propagated in a direction different from that toward a laser light receiving section. To the contrary, with a surface profile having excessively larger peak and valley height and roughness spacing of the tooth crown portion 1, a surface shape of the tooth model is altered in a way such that a good result cannot be obtained in shape measurement using laser light.

In the present invention, it is necessary for a center-line average roughness Ra to be generally 0.1 μm or more and less than 10 μm and desirably 0.15 μm or more and less than 5 μm and a better shape measurement result can be obtained by adjusting the center-line average roughness within in the ranges.

A surface roughness defined in the present invention is one measured according to JIS B 0601-1982, and defined as a center-line average roughness Ra is the average value of results of measurement on the flattest possible surface of a tooth crown portion obtained at any site and in any direction therein three times, respectively. Note that measurement of a surface roughness is conducted respectively at any site measured in a tooth crown portion in conditions of a measuring length of 0.5 mm, a measuring speed of 0.03 mm/sec and a cut-off value of 0.08 mm.

In the present invention, when a light reflectance of the surface of a tooth crown portion is low, reflecting light of laser light to be used for measurement is weak to thereby disable a good measurement result to be obtained, which requires a light reflectance of the surface of a tooth crown portion of 70% or more for light of 700 nm in wavelength. The term, a light reflectance, herein means a reflectance including direct reflection according to JIS Z 8722-1982. In the present invention, a light reflectance is defined as the average value of results of measurement on the flattest possible surface of a tooth crown portion obtained at any site therein three times.

In the present invention, in order to obtain a light reflectance of the surface of a tooth model of 70% or more, it is necessary for a material of the surface of a tooth crown portion to have non-transparency or semi-transparency. That is, when a material of which a tooth crown portion is made has non-transparency or semi-transparency, there can be obtained a comparatively high light reflectance value, whereas if a material of which a tooth crown portion is made has transparency, a light quantity transmitted through the material increases and thereby a light reflectance is lower, leading to a measurement data deficient area.

As materials of the surface of a tooth crown portion of a tooth model of the present invention (a tooth crown portion forming material), there can be employed generally known ones, which are exemplified as follows: porcelain such as ceramics and the like; thermoplastic resin materials such as acrylate, polystyrene, polycarbonate, acrylonitrile-styrene-butadiene copolymer (ABS), polypropylene, polyethylene, polyester and the like; and thermoset resin materials such as melamine, urea, unsaturated polyester, phenol, epoxy and the like, and as various kinds of additives that can be used in combination with a material described above as a main ingredient, exemplified are various kinds of organic or inorganic reinforcing fibers such as a glass fiber, a carbon fiber, pulp, a synthetic resin fiber and the like; various kinds of fillers such as talk, silica, mica, calcium carbonate, barium sulfate, alumina and the like; colorants such as pigments, dyes and the like; and various kinds of other additives such as a weather resistance agent, an antistatic agent and the like.

No specific limitation is imposed on a color tone of a tooth crown portion forming material, but desirable is a slightly off-white color. No specific limitation is placed on a way of toning and it is only required that some of various kinds of known pigments and dyes are properly combined so as to obtain a desired color tone. In the present invention, a color tone of a tooth crown portion forming material is adjusted so as to be preferably 15 or less and more preferably 10 or less in color difference ΔE*ab relative to a standard white color, thereby a good result of tooth shape measurement using laser light can be obtained.

The term, a standard white color, means a color of a white color proof board for a color difference meter manufactured according to JIS Z 8722 and a color difference ΔE*ab in the present invention is defined as the average value of results of measurement on the surface of a test piece formed so as to be flat obtained at any three sites therein using a color difference meter manufactured according to JIS Z 8722.

In a case where such a tooth model for dentistry training of the present invention is manufactured, a manufacturing method is properly selected according to a used material, however, for example, if a synthetic resin is used as a main ingredient, there can be employed known methods such as a injection molding method, a press molding method and the like.

In order to form fine concavity and convexity on the surface of a tooth crown portion, the process for forming concavity and convexity may be simultaneously conducted during the course of forming a tooth model or may be applied as a subsequent step after the forming. In order to form fine concavity and convexity on the surface of a tooth crown portion simultaneously with the forming thereof, for example, in a case where a raw material including a synthetic resin is used as a main component thereof, it is only required that fine concavity and convexity is formed on the surface of a mold to thereby enable the reverse profile to be transferred on the surface of an obtained tooth. On the other hand, in a case where a profile with fine concavity and convexity is formed on the surface of a tooth model in a post-treatment, there can be employed known methods on the surface of a tooth model already formed such as a blasting treatment blasting fine powder, an etching treatment using a chemical, a surface treatment with a sand paper or an abrasive powder and the like. Of various kinds of such known methods, preferably used are a blasting treatment or an etching treatment forming a profile with fine concavity and convexity being applied on the surface of a molded tooth model in a later step because of being capable of obtaining a uniform concavity and convexity.

By the use of a method described above, a tooth model for dentistry training capable of correct shape measurement using laser light can be easily obtained.

### EXAMPLES

A material prepared by the method in which pulp was mixed into a melamine resin as a filler, and a pigment is added to the mixture to obtain a desired color tone was molded by injection molding to form a tooth model for dentistry training having a shape shown in FIG. 1, and a treatment for forming fine concavity and convexity on the surface of a tooth crown portion thereof is performed by using one of methods shown in respective examples. Measurement was conducted on completed tooth models about a center line average roughness Ra, a light reflectance and a color difference ΔE*ab from a standard white color.

A center-line average roughness Ra was measured with a Surfcom 570A (manufactured by TOKYO SEIMITSU Co., Ltd.), a light reflectance was measured with a spectrocolorimeter CM-3600d (manufactured by Konica Minolta) and a color difference ΔE*ab from a standard white color was measured with a color difference meter CR300 (manufactured by Konica Minolta with a data processor DP300).

Shape measurement of the tooth models was conducted with a non-contact, high speed, three-dimensional shape measuring instrument VMS-100X (manufactured by Unisn INC.). Evaluation on results of measurement was determined by the counts of data deficient portions occurring as holes in the results of measurement and a tooth model with no data deficient portion was evaluated as a good result. Measured values and shape measurement results on the tooth models are shown in Table 1.

### Example 1

A material colored in a white color of 4.92 in a color difference ΔE*ab from a standard white color was molded by injection molding, then, the molded product was subjected to a blasting treatment using aluminum oxide particles of the order in the range of from 10 to 80 μm in particle diameter to obtain a tooth model with a surface having a profile with concavity and convexity of a center-line average roughness Ra=0.19 μm and a light reflectance of 81.43% and thereafter, shape measurement was conducted on the tooth model. As a result, a good shape measurement result was achieved without any data deficient portion.

### Example 2

A tooth model molded in a similar way to that adopted in Example 1 was subjected to an etching treatment with a chemical to obtain the tooth model with a surf ace having a profile with concavity and convexity of a center-line average roughness Ra=1.01 μm and a light reflectance of 82.74% and thereafter, shape measurement was conducted on the tooth model. As a result, a good shape measurement result was achieved without any data deficient portion.

### Comparative Example 1

A material similar to those used in Examples 1 and 2 were molded by injection molding and thereafter, a fabricated tooth model was subjected to a barrel polishing with an abrasive which is ceramic spheres of the order of 1 mm to 2 mm in diameter to thereby obtain the tooth model with a surface having a profile with concavity and convexity of a center-line average roughness Ra=0.09 μm and a light reflectance of 83.34% and thereafter, shape measurement was conducted on the tooth model. As a result, two portions of data deficiency like holes in shape occurred, thereby not leading to a good measurement result.

### Comparative Example 2

A material colored in a skin color of 17.09 in color difference ΔE*ab from a standard white color was molded by injection molding, then, the fabricated tooth model was subjected to a blasting treatment using aluminum oxide particles of the order in the range of from 10 to 80 μm in particle diameter to thereby obtain the tooth model with a surface having a profile with concavity and convexity of a center-line average roughness Ra=0.13 μm and a light reflectance of 62.88% and thereafter, shape measurement was conducted on the tooth model. As a result, four portions of data deficiency like holes in shape occurred, thereby not leading to a good measurement result.

### Comparative Example 3

A material similar to that used in Comparative Example 2 was molded by injection molding and thereafter, a fabricated tooth model was subjected to a barrel polishing with an abrasive which is ceramic spheres of the order in the range of from 1 mm to 2 mm in diameter to thereby obtain the tooth model with a surface having a profile with concavity and convexity of a center-line average roughness Ra=0.08 μm and a light reflectance of 65.75% and thereafter, shape measurement was conducted on the tooth model. As a result, four portions of data deficiency like holes in shape occurred, thereby not leading to a good measurement result.

TABLE 1
Measurement result as to tooth models described in Example
1, Example 2, and Comparative Examples 1 to 3

| | | | | Result of shape |
|---|---|---|---|---|
| | | | | measurement |
| | | | | (portions of |
| | Color | Center- | | data |
| | difference | line average | Light | deficiency in |
| | ΔE*ab | roughness Ra | reflectance | shape) |
| Example 1 | 4.92 | 0.19 μm | 81.43% | ∘ (0 portion) |
| Example 2 | 4.92 | 1.01 μm | 82.74% | ∘ (0 portion) |
| Comparative | 4.92 | 0.09 μm | 83.34% | x (2 portions) |
| Example 1 | | | | |
| Comparative | 17.09 | 0.13 μm | 62.88% | x (4 portions) |
| Example 2 | | | | |
| Comparative | 17.09 | 0.08 μm | 65.75% | x (4 portions) |
| Example 3 | | | | |

### INDUSTRIAL APPLICABILITY

As seen from the results of the comparative experiments shown in Table 1, in a case of a tooth model for dentistry training of the present invention, the shape of a tooth crown portion of a tooth model can be correctly measured by a non-contact, high speed, three-dimensional shape measuring instrument and by using the shape measurement, results of various kinds of a treatment practice and a preparation practice can be correctly evaluated in the educational field.

1. A tooth model for dentistry training having a tooth crown portion formed as an imitation of the shape of a tooth, wherein at least the tooth crown portion is made of a tooth crown portion forming material having non-transparency or semi-transparency, a center-line average roughness Ra of the surface of the tooth crown portion is 0.1 μm or more and less than 10 μm and a light reflectance of the surface of the tooth crown portion is 70% or higher for light of 700 nm in wavelength.

2. The tooth model for dentistry training according to claim 1, wherein a color difference ΔE*ab from a standard white color of the tooth crown portion forming material is 15 or less.
